(19) United States
(12) Patent Application Publication
(10) Pub. No.: US 2012/0142577 A1
(43) Pub. Date: Jun. 7, 2012

(54) Biodegradable Amphoteric Surfactants Based on C6 to C11 Linear or Predominately Linear Alcohols

(75) Inventors: Xiangdong Sun, Newton, PA (US); Karen Alyce Kennedy, Breinigsville, PA (US); Khalil Yacoub, Allentown, PA (US); Richard Joseph Goddard, Fogelsville, PA (US)

(73) Assignee: Air Products and Chemicals, Inc., Allentown, PA (US)

(21) Appl. No.: 13/043,817

(22) Filed: Mar. 9, 2011

Related U.S. Application Data
(60) Provisional application No. 61/311,930, filed on Mar. 9, 2010.

(51) Int. Cl. C11D 3/60; C11D 1/94

(52) U.S. Cl. 510/479

(57) ABSTRACT

A biodegradable amphoteric surfactant is disclosed. The surfactant, has excellent coupling efficiency, low to moderate foam, and good detergency. Amphoteric surfactants based on linear alkyl radicals or predominately linear alkyl radicals (R) of 6 to 11 carbons, and mixtures thereof are also disclosed.

This application claims the benefit of U.S. Provisional Application No. 61/311,930, filed on Mar. 9, 2010. The disclosure of Application No. 61/311,930 is hereby incorporated by reference.

### BACKGROUND OF THE INVENTION

The subject matter of the instant invention relates to biodegradable amphoteric surfactants and to compositions including these surfactants.

Amphoteric surfactant structures are known in the art. One example of a known surfactant structure, is disclosed in U.S. Pat. No. 3,417,136 which discloses synthesis and use of amphoteric structures; the disclosure of which is hereby incorporated by reference. There is a need in this art for an amphoteric surfactant that is biodegradable, but that also has excellent coupling efficiency, low to moderate foam, and good detergency.

### BRIEF SUMMARY OF THE INVENTION

The instant invention solves problems associated with the prior art by providing an amphoteric surfactant that is biodegradable, has excellent coupling efficiency, low to moderate foam, and good detergency. Surprisingly, amphoteric surfactants based on linear alkyl radicals or predominately linear alkyl radicals (R) of 6 to 11 carbons, and mixtures thereof, yield surfactants that are ultimately biodegradable, produce low to moderate foam in cleaners (e.g., hard surface cleaners), and whose coupling efficiency is desirable (e.g., an efficiency that is comparable to amphoteric surfactants based on an isoalkyl radical).

By “biodegradable” it is meant that a compound or blends thereof meets the criteria for “ultimate biodegradability” as set forth in Annex III of Regulation (EC) No 648/2004 of the European Parliament and of the Council.

By “coupling efficiency” it is meant that a compound or blends thereof yield single-phase and clear solutions when added to a formula that is otherwise hazy or phase separated, or that the addition of a compound or blend thereof increases the cloud point of the formula. For example, the inventive surfactant and combinations or blends thereof typically have a coupling efficiency as defined by Formula A (Example 3 below) wherein 1.5 g or less of a 30 to 35 wt % active inventive amphoteric surfactant is required to obtain a single-phase and visually clear formula, or as defined by Formula B (Example 3) wherein 2.5 g or less of a 30 to 35 wt % active inventive amphoteric surfactant is required to obtain a single-phase and visually clear formula, or as defined by Formula C (Example 4) wherein the addition of a 30 to 35 wt % active inventive amphoteric surfactant yields a cloud point at least 10° C. greater than the cloud point obtained in Formula C where the amphoteric surfactant comprises β-Alanine, N-(2-carboxyethyl)-, N-[3-(C12-15-alkyloxy)propyl] derivs, and monosodium salts (e.g., commercially available as Tomamine® Amphoteric N surfactant)

By “low to moderate foam” it is meant that a compound or blends thereof produce a foam with initial height of less than about 12 cm when measured at a concentration of about 0.1 wt % in water and a temperature of about 25° C. in accordance with ASTM D-1173. Typically the inventive surfactant has an initial foam height of less than about 12 cm. In certain cases the initial foam height is less than about 6 cm, and in other cases less than about 3 cm.

By “detergency” it is meant that a compound or blends thereof increases soil removal when added to a cleaning formulation.

One aspect of the invention relates to a cleaning composition that comprises the inventive surfactant. Cleaning formulations that include the inventive amphoteric surfactants are those of Structure 1 (shown below) wherein R is a linear alkyl radical of 6 to 11 carbons, a predominately linear alkyl radical of 6 to 11 carbons, and mixtures thereof, or a linear alkyl radical of 8 to 10 carbons, a predominately linear alkyl radical of 8 to 10 carbons. Predominately linear alkyl radicals include those with only one secondary carbon, for example ethylhexyl, ethylheptyl, or alkyl mixtures that contain greater than about 60%, typically greater than about 70%, and preferably greater than about 80% n-alkyl. Predominately linear means that most of the radicals are n-alkyl (e.g., typically about 80% linear and about 20% single branch.

### DETAILED DESCRIPTION OF THE INVENTION

The instant invention relates broadly to a surfactant and to compositions (e.g., cleaning compositions), including the surfactant. The instant invention relates more particularly to an amphoteric surfactant that is biodegradable, has excellent coupling efficiency, low to moderate foam, and good detergency. Amphoteric surfactants based on linear alkyl radicals or predominately linear alkyl radicals (R) of 6 to 11 carbons, and mixtures thereof, can yield surfactants that are biodegradable, produce low to moderate foam in cleaners (e.g., hard surface cleaners), and have a desirable coupling efficiency (e.g., an efficiency that is comparable to amphoteric surfactants based on an isoalkyl radical).

One aspect of the instant invention relates to a cleaning composition or formulation. Cleaning formulations that include desired amphoteric surfactants comprise those of Structure 1 (shown below) where R is a linear alkyl radical of 6 to 11 carbons, a predominately linear alkyl radical of 6 to 11 carbons, and mixtures thereof. Predominately linear alkyl radicals include those with only one secondary carbon, for example ethylhexyl, or alkyl mixtures that contain greater than about 60%, usually greater than about 70%, and typically greater than about 80% n-alkyl.

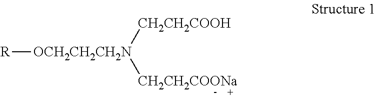

One aspect of the invention relates to incorporating the alkyl radical of Structure 1 by way of an alcohol reactant ROH. Suitable alcohols that yield suitable amphoteric surfactants of Structure 1 include linear alcohols: n-hexanol, n-heptanol, n-octanol, n-nonanol, n-decanol and n-undecyl alcohol; alcohols with only one secondary carbon such as 2-ethyl-1-hexanol; commercially available blends of linear alcohols such as Alfol® 68 (available from Sasol), Alfol 610, Alfol 810; commercially available predominately linear alcohols and blends of predominately linear alcohols such as Neodol® 79 (available from Shell), Neodol 91 and Neodol 1; and mixtures thereof. Reaction of a suitable alcohol to yield an amphoteric surfactant of Structure 1 follows the general procedure and conditions of U.S. Pat. No. 3,417,136, starting with 1 mole of suitable alcohol, reacted by Michael Addition with 1 mole acrylonitrile in the presence of aqueous potassium hydroxide. The obtained alkyl ether nitrile can be filtered over diatomaceous earth and hydrogenated by conditions of U.S. Pat. No. 3,417,136 until the nitrile is consumed. The alkyl oxypropylamine is then filtered and further reacted with 2.2 moles of acrylic acid in an aqueous medium at 80° C. for twenty hours. Aqueous sodium hydroxide (1.1 moles) was charged and additional water added to attain a 30 to 35% active amphoteric surfactant of Structure 1.

Another aspect of the invention relates to a composition comprising the inventive surfactant or Structure 1 as set forth below:

| Ingredient | Amount - Weight Percent | |
|---|---|---|
| Non-amphoteric surfactants | 0.5 to 30 | wt % |
| Builders | 0.5 to 40 | wt % |
| Solvents (optional) | 0 to 30 | wt % |
| Other additives (optional) | 0 to 10 | wt % |
| Inventive amphoteric surfactants | 0.5 to 20 | wt % |

| | |
|---|---|
| Water | balance |

The inventive composition can be employed for cleaning a wide range of hard surfaces such as tile floors, concrete floors, wood floors, interior walls, exterior walls and siding, glass, windows, windshields, metal, plastic, leather, toilets, tubs, shower enclosures, sinks, bathroom fixtures, countertops, furniture, desks, computers, kitchen surfaces, ovens, stovetops, dishes, industrial equipment and tools, metal parts, metal tanks, vehicles, aircraft, and wheels. The inventive composition can also be employed for cleaning a wide range of soft surfaces such as laundry, carpet, upholstery and textiles. The inventive composition can also be added to another composition in order to improve the properties thereof.

While any suitable non-amphoteric surfactants and mixtures thereof can be used in compositions in accordance with the instant invention, examples of suitable non-amphoteric surfactants comprise at least one member selected from the group consisting of nonionic surfactants: ethoxylated alcohols, alkoxylated alcohols, ethoxylated linear alcohols, ethoxylated guerbet alcohols, ethoxylated primary alcohols, ethoxylated secondary alcohols, ethoxylated nonylphenol, ethoxylated octylphenol, ethoxylated amines, amine oxides, alkyl polyglucosides, polysorbates, cocoamides; anionic surfactants: alkyl ether sulfates, alkyl ether carboxylic acids, alcohol sulfates, alkyl sulfates, olefin sulfonates, alkyl benzene sulfonates, dodecyl benzene sulfonic acid, alkyl sulfoacetates, alkyl sulfosuccinates, dialkyl sulfosuccinates; cationic surfactants-alkyl trimethylammonium halides or methyl sulfates, alkyl triethylammonium halides or methyl sulfates, alkyl bis-ethoxy methylammonium halides or methyl sulfates, polyethoxylated alkyl amines, polyethoxylated alkyl methylammonium halides, alkyl pyridinium halides, alkyldimethylbenzylammonium halides; and mixtures thereof.

The inventive composition can further comprise at least one builder. By “builder” it is meant that a compound that controls mineral hardness and assists the removal of particulate soils. While any suitable builder and mixtures thereof can be used in a cleaning composition in accordance with the instant invention, examples of suitable builders comprise at least one member selected from the group consisting of one or more of sodium hydroxide, potassium hydroxide, ammonium hydroxide, sodium metasilicate, sodium silicate, potassium silicate, sodium carbonate, sodium bicarbonate, tetrapotassium pyrophosphate, trisodium phosphate, sodium tripolyphosphate, glycolic acid, acetic acid, oxalic acid, formic acid, citric acid, hydroxyacetic acid, hydrochloric acid, hydrofluoric acid, sulfuric acid, sulfamic acid, phosphoric acid, phosphonic acid; and mixtures thereof.

If desired, a carrier or solvent can be employed in the composition of the instant invention. While any suitable carrier or solvent can be employed, examples of suitable solvents comprise at least one member selected from the group consisting of one or more of ethylene glycol butyl ether, diethylene glycol butyl ether, dipropylene glycol methyl ether, dipropylene glycol butyl ether, d-limonene, pine oil, mineral oil, isopropyl alcohol, acetone, methanol, ethanol; and mixtures thereof.

Depending upon the end-use of the inventive compositions one or more additives can be included. While any suitable additives can be included, examples of suitable additives comprise at least one member selected from the group consisting of chelants: ethylene diamine tetraacetic acid, sodium salts of nitrilotriacetic acid, sodium gluconate, Baypure® CX 100 (available from Lanxess Corporation); antimicrobial agents; bleach; hydrogen peroxide; monoethanolamine, diethanolamine, triethanolamine; sodium xylene sulfonate; enzymes; preservatives, dyes and fragrances.

The inventive cleaning compositions can be prepared by any suitable method and in any suitable equipment. A simple blend vessel with standard mechanical agitation is often employed.

The following Examples are provided to illustrate certain aspects of the invention and shall not limit the scope of any claims appended hereto.

### EXAMPLES

### Example 1

Structure 1 with R=alkyl radical of n-octanol, 33 wt % (the balance being water) was prepared by cyanoethylating n-octanol in the presence of a potassium hydroxide catalyst. One mole of n-octanol and 0.1 percent by weight of potassium hydroxide were placed in a reactor vessel and heated with agitation before adding 1 mole acrylonitrile. The acrylonitrile was added at a rate such that the temperature did not exceed 45° C. The octyl ether nitrile was recovered by filtration. The octyl ether nitrile was hydrogenated in the presence of a Raney nickel catalyst at 125° C. and with an ammonia partial pressure of 100 p. s. i. a. and a hydrogen partial pressure of 400 p. s. i. a. for a period of three hours. The resultant octyloxypropylamine was filtered and further reacted with 2.2 moles of acrylic acid in an aqueous medium at 80° C. for twenty hours. Aqueous sodium hydroxide (1.1 moles) was charged and additional water added to attain a 30 to 35% active amphoteric surfactant of Structure 1

### Example 2

Structure 1 with R=alkyl radicals of Neodol® 91 alcohol (available from Shell), a blend of predominately linear alcohols with 9 to 11 carbons, 33 wt % (the balance being water) was prepared by reaction of 1 mole Neodol 91 alcohol, 1 mole acrylonitrile, hydrogen, 2.2 moles of acrylic acid and 1.1 moles of aqueous sodium hydroxide according to the process described in Example 1. Additional water was added to obtain the 33 wt % active amphoteric surfactant.

### Example 3

Approximately 100 g of the following formulae were blended together in a 250 ml Erlenmeyer flask using a magnetic stir bar, and the amount of amphoteric surfactant required to produce a single-phase and visually clear solution at 20° C. was determined.

| | Ingredient | wt % |
|---|---|---|
| Formula A: | Tomadol ® 900 surfactant | 2.0 |
| | Proprietary blend of ethoxylated | |
| | alcohols having an HLB of 13.1 | |
| | Potassium hydroxide, 45 wt % | 20.0 |
| | Sodium metasilicate 3.22/1 | 20.0 |
| | Sodium gluconate | 2.0 |
| | Amphoteric surfactant | as needed to obtain |
| | | clear solution |
| | Water | balance |

| | Ingredient | wt % |
|---|---|---|
| Formula B: | Nonylphenol ethoxylate surfactant | 2.0 |
| | having an HLB of 12.9 | |
| | Potassium hydroxide, 45 wt % | 20.0 |
| | Sodium metasilicate 3.22/1 | 20.0 |
| | Sodium gluconate | 2.0 |
| | Amphoteric surfactant | as needed to obtain |
| | | clear solution |
| | Water | balance |

TABLE 1
Wt % of amphoteric surfactant to achieve
clear solution in Formula A and Formula B

| Amphoteric surfactant | Formula A | Formula B |
|---|---|---|
| Tomamine ® Alkali Surfactant | 1.5 | 2.5 |
| Tomamine ® Amphoteric N | 2.0 | 3.0 |
| b-Alanine, N-(2-carboxyethyl)-, N- | | |
| [3-(C12-15-alkyloxy)propyl] derivs., | | |
| monosodium salts | | |
| Example 1 | 1.5 | 2.0 |
| Example 2 | 1.5 | 2.5 |

Both Example 1 and Example 2 produced clear solutions at equal or lower concentrations to Tomamine® Alkali Surfactant, and were more efficient at forming clear solutions than Tomamine® Amphoteric N in all cases.

### Example 4

Approximately 100 g of the following formula was blended together in a 250 ml Erlenmeyer flask using a magnetic stir bar, and the cloud point was measured using ASTM Method D2024.

| | Ingredient | wt % |
|---|---|---|
| Formula C: | NP-9EO surfactant (nonylphenol | 5.0 |
| | with 9 moles of EO) | |
| | potassium hydroxide, 45 wt % | 20.25 |
| | Amphoteric surfactant | 3.75 |
| | Water | 71.0 |

TABLE 2
Cloud point of Formula C with amphoteric surfactant

| | Formula C |
|---|---|
| | Cloud Point |
| Amphoteric surfactant | ° C. |
| Control with no amphoteric surfactant | <20 |
| Tomamine ® Alkali Surfactant | 49 |
| Tomamine ® Amphoteric N | 33 |
| Example 1 | 47 |
| Example 2 | 48 |

Both Example 1 and Example 2 yield a cloud point comparable to Tomamine® Alkali Surfactant, and markedly greater than the cloud point obtained with Tomamine Amphoteric N. The Cloud point of Formula C increases the utility of this formula in cleaning applications.

### Example 5

Foam height and stability of 0.1 wt % amphoteric surfactant solutions were determined at 25° C. in water of 150 ppm hardness using ASTM D-1173. Foam height was measured at time zero (initial) and at 5 minutes.

| | Foam Height | Foam Height |
|---|---|---|
| Amphoteric surfactant | @ t = 0, cm | @ t = 5 min, cm |
| Tomamine ® Alkali Surfactant | 13.0 | 4.0 |
| Tomamine ® Amphoteric N | 18.0 | 18.0 |
| Example 1 | 2.5 | 2.0 |
| Example 2 | 10.5 | 9.5 |

Tomamine Amphoteric N surfactant, where the alkyl radical R is predominately linear, produces high and stable foam that is undesirable in many applications. The foam produced by Tomamine Alkali Surfactant, where R is a branched isodecyl radical, is of lower initial height and less stable. Surprisingly the amphoteric surfactants of Example 1 and Example 2, based on linear or predominately linear alkyl radicals, yield foams that are low to moderate in initial height.

### Example 6

The biodegradability of the composition of Examples 1 and 2 was determined in accordance with OECD Method 301F in an aqueous aerobic medium. The biodegradation was 67% in 28 days when R was a linear alkyl radical of 8 carbons (Example 1), or 69% when R is a blend of predominately linear alkyl radicals of 9 to 11 carbons (Example 2), which are both ultimately biodegradable.

While the invention has been described with reference to certain embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A composition comprising:
at least one non-amphoteric surfactant in an amount of about 0.5 to about 30 wt %,
at least one builder in an amount of about 0.5 to about 40 wt %,
at least one amphoteric surfactant in an amount of about 0.5 to about 20 wt %; and,
the balance water; wherein the amphoteric surfactant comprises: 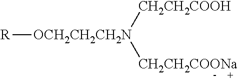
Wherein R is a linear alkyl radical of 6 to 11 carbons, a predominately linear alkyl radical of 6 to 11 carbons and mixtures thereof; and combinations of the foregoing.

2. The composition of claim 1 further comprising at least one solvents in an amount greater than about 0 to about 30 wt %.

3. The composition of claim 1 further comprising at least one additive in an amount greater than about 0 to 10 wt %.

4. The composition of claim 1 wherein the composition comprises a biodegradable cleaning formulation.

5. The composition of claim 1 wherein the amphoteric surfactant has a coupling efficiency equivalent to an isoalkyl radical.

6. The composition of claim 1 wherein the non-amphoteric surfactant comprises at least one member selected from the group consisting of nonionic surfactants: ethoxylated alcohols, alkoxylated alcohols, ethoxylated linear alcohols, ethoxylated guerbet alcohols, ethoxylated primary alcohols, ethoxylated secondary alcohols, ethoxylated nonylphenol, ethoxylated octylphenol, ethoxylated amines, amine oxides, alkyl polyglucosides, polysorbates, cocoamides; anionic surfactants: alkyl ether sulfates, alkyl ether carboxylic acids, alcohol sulfates, alkyl sulfates, olefin sulfonates, alkyl benzene sulfonates, dodecyl benzene sulfonic acid, alkyl sulfoacetates, alkyl sulfosuccinates, dialkyl sulfosuccinates; cationic surfactants-alkyl trimethylammonium halides or methyl sulfates, alkyl triethylammonium halides or methyl sulfates, alkyl bis-ethoxy methylammonium halides or methyl sulfates, polyethoxylated alkyl amines, polyethoxylated alkyl methylammonium halides, alkyl pyridinium halides, alkyldimethylbenzylammonium halides; and mixtures thereof.

7. The composition of claim 1 wherein the builder comprises at least one member selected from the group consisting of one or more of sodium hydroxide, potassium hydroxide, ammonium hydroxide, sodium metasilicate, sodium silicate, potassium silicate, sodium carbonate, sodium bicarbonate, tetrapotassium pyrophosphate, trisodium phosphate, sodium tripolyphosphate, glycolic acid, acetic acid, oxalic acid, formic acid, citric acid, hydroxyacetic acid, hydrochloric acid, hydrofluoric acid, sulfuric acid, sulfamic acid, phosphoric acid, phosphonic acid; and mixtures thereof.

8. The composition of claim 2 wherein the solvent comprises at least one member selected from the group consisting of one or more of ethylene glycol butyl ether, diethylene glycol butyl ether, dipropylene glycol methyl ether, dipropylene glycol butyl ether, d-limonene, pine oil, mineral oil, isopropyl alcohol, acetone, methanol, ethanol;
and mixtures thereof.

9. The composition of claim 3 wherein the additive comprises at least one member selected from the group consisting of chelants: ethylene diamine tetraacetic acid, sodium salts of nitrilotriacetic acid, sodium gluconate, antimicrobial agents; bleach; hydrogen peroxide; monoethanolamine, diethanolamine, triethanolamine; sodium xylene sulfonate; enzymes; preservatives, dyes and fragrances.

10. A composition comprising:
at least one non-amphoteric surfactant, and,
at least one amphoteric surfactant wherein the amphoteric surfactant comprises: 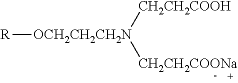
Wherein R is a linear alkyl radical of 6 to 11 carbons, a predominately linear alkyl radical of 6 to 11 carbons and mixtures thereof and is a reaction product of at least one alcohol and acrylonitrile.

11. The composition of claim 10 wherein the non-amphoteric surfactant comprises a blend of ethoxylated alcohols having an HLB of about 13.1

12. The composition of claim 11 further comprising at least one builder.

13. The composition of claim 12 wherein the builder comprises tetrapotassium pyrophosphate.

14. The composition of claim 12 further comprising at least one solvent.

15. The composition of claim 10 wherein the alcohol comprises n-octanol.

16. The composition of claim 10 wherein the alcohol comprises a linear alcohol with 9 to 11 carbons.

17. Use of a biodegradable composition of claim 10 for cleaning.
